(19) United States
(12) Patent Application Publication
(10) Pub. No.: US 2025/0154311 A1
(43) Pub. Date: May 15, 2025

(54) BIOBASED POLYURETHANE RESIN COMPOSITION, MANUFACTURING METHOD AND USE IN PARTICULAR IN THE TECHNIQUE OF DOMING

(71) Applicants: INOMËA, Laverune (FR); CENTRE NATIONAL DE LA RECHERCHE SCIENTIFIQUE, Paris (FR); UNIVERSITE DE MONTPELLIER, Montpellier (FR); ECOLE NATIONALE SUPERIEURE DE CHIMIE DE MONTPELLIER, Montpellier (FR)

(72) Inventors: Alienor Delavarde, Montpellier (FR); Sylvain Maillard, Laverune (FR); Sylvain Caillol, Montpellier (FR); Julien Pinaud, Quissac (FR)

(73) Assignees: INOMËA, Laverune (FR); CENTRE NATIONAL DE LA RECHERCHE SCIENTIFIQUE, Paris (FR); UNIVERSITE DE MONTPELLIER, Montpellier (FR); ECOLE NATIONALE SUPERIEURE DE CHIMIE DE MONTPELLIER, Montpellier (FR)

(21) Appl. No.: 18/836,119

(22) PCT Filed: Feb. 18, 2022
(86) PCT No.: PCT/FR2022/000011

§ 371 Date: Aug. 6, 2024

(51) Int. Cl. C08G 18/12; C08G 18/24; C08G 18/48

(52) U.S. Cl. CPC C08G 18/12; C08G 18/246; C08G 18/4808; C08G 18/4845; C08G 18/4891

(57) ABSTRACT

THE biobased polyurethane resin composition is obtained by mixing a volume v1 of polyisocyanate phase, and a volume v2 of polyol phase, WHERE: either the polyisocyanate phase INCLUDES at least two polyisocyanates which each INCLUDE at least 25% of biobased carbons, and the polyol phase INCLUDES at least one polyol which INCLUDES at least 80% of biobased carbons, or the polyol phase INCLUDES at least two polyols which each INCLUDES at least 80% of biobased carbons, and the polyisocyanate phase INCLUDES at least one polyisocyanate which INCLUDES at least 25% of biobased carbons. Preferentially, the number of isocyanate functions in the polyisocyanate phase is equal to the number of alcohol functions in the polyol phase. A method for manufacturing such a composition advantageously involves EVALUATING the equivalent volumes of reactive function of each compound. A printed support covered at least partly with a dome of resin produced from THE composition.

### TECHNICAL FIELD OF THE INVENTION

The invention relates to the field of polyurethane resins, and more particularly to biobased polyurethane resins.

The invention notably finds application in the field of doming.

### TECHNOLOGICAL BACKGROUND OF THE INVENTION

The application of a resin dome to a printed support is a well-known technique for imparting a three-dimensional character to a two-dimensional image. To achieve this, a transparent or translucent liquid two-component polyurethane resin is deposited on a non-porous printed support. The progress of the resin on the support is interrupted at the support's cut edge, and the surface tension of the resin holds it in place on the support. Once dry, the resin is in the form of a dome, imparting a lens-like effect to the support print. This is why doming is also presented as the technique that allows three-dimensional labels to be produced.

It is well known that the resins used in this field are polyurethane resins obtained by mixing two phases: one containing polyols, the other polyisocyanates. A polyol/polyisocyanate is a chemical compound bearing at least two alcohol/isocyanate functions (—OH/—OCN). A transparent liquid is obtained after mixing these two phases. Once deposited on the support, this liquid hardens in a few minutes, leaving a more or less flexible and translucent material.

Conventionally used polyurethane resins are resins synthesized from starting materials (polyisocyanates and polyols) of petrochemical origin.

In addition to the petrochemical nature of the derivatives, isocyanate compounds are hazardous. In most cases, they are classified as toxic, mutagenic, carcinogenic, reprotoxic and environmentally hazardous compounds.

Without being restricted to doming applications, polyurethane resin must meet a certain number of criteria in the field of doming. The resin must be transparent to allow the support's print to be seen, the viscosity of the polyol and polyisocyanate phases must be less than 900 mPa·s at 25° C., the resin must polymerize at room temperature, its gel time must be greater than 1 hour and, as a precaution, greater than or equal to 3 hours, and its shore A hardness must be similar to that of synthetic resins, i.e. between 40 and 90 ShA.

There are currently few biobased polyisocyanates to choose from, and none of them, as mixtures with a polyol, allows a polyurethane resin that meets the above criteria to be produced.

### SUMMARY OF THE INVENTION

In this context, the invention is directed toward a novel polyurethane resin formulation prepared using biobased polyol and polyurethane compounds.

The invention also covers a process for manufacturing such resins, which is notably suited to the application constraints in the field of doming.

The invention is also directed toward a printed support covered with a dome consisting of such a resin.

To this end, the biobased polyurethane resin composition of the invention is essentially characterized in that it is obtained by mixing a volume V1 of polyisocyanate phase, and a volume V2 of polyol phase, and in that:
either the polyisocyanate phase comprises at least two polyisocyanates each including at least 25% of biobased carbons, and the polyol phase comprises at least one polyol including at least 80% of biobased carbons,
or the polyol phase comprises at least two polyols each including at least 80% of biobased carbons, and the polyisocyanate phase comprises at least one polyisocyanate including at least 25% of biobased carbons.

The composition of the invention may also include the following optional features considered in isolation or in any possible technical combination:
the composition comprises at least one trifunctional compound in its polyisocyanate phase and/or in its polyol phase, for example a diisocyanate isocyanurate which includes at least 60% of biobased carbons,
the number of isocyanate functions in the polyisocyanate phase is equal to the number of alcohol functions in the polyol phase,
the polyisocyanate phase comprises at least one diisocyanate isocyanurate which includes at least 60% of biobased carbons, and the polyol phase comprises at least one polyether polyol which includes 100% of biobased carbons. This composition advantageously makes it possible to combine the presence of a trifunctional compound for the doming field, and a compound including 100% of biobased carbons.
the composition is obtained by mixing a volume V1 of polyisocyanate phase comprising at least two polyisocyanates which each include at least 25% of biobased carbons, and a volume V2 of polyol phase comprising at least two polyols which each include at least 80% of biobased carbons. Such a composition advantageously allows easy modulation of the number of isocyanate functions in the polyisocyanate phase and the number of alcohol functions in the polyol phase, given the limited choice of biobased compounds on the market, in particular biobased polyisocyanates.
the composition is obtained by mixing a polyisocyanate phase comprising at least two polyisocyanates, one of which includes at least 50% of biobased carbons, and a polyol phase comprising at least two polyols, each of which includes at least 90% of biobased carbons,
the polyisocyanate phase is made from a mixture of diisocyanate isocyanurate which includes at least 60% of biobased carbons and diisocyanate allophanate which includes at least 25% of biobased carbons,
the polyol phase is made from two different polyols including 100% of biobased carbons,
the polyol phase comprises either two polyether polyols or one polyether polyol and castor oil,
the polyol phase comprises a poly(1,3-propanediol) with a molar mass of between 200 and 300 g/mol and a poly(1,3-propanediol) with a molar mass of between 400 and 600 g/mol,
the composition is obtained by mixing the same volume of polyisocyanate phase and polyol phase, and the number of isocyanate functions in the polyisocyanate phase is equal to the number of alcohol functions in the polyol phase,
the isocyanate phase is a mixture of diisocyanate isocyanurate which includes at least 60% of biobased carbons and diisocyanate allophanate which includes at least 25% of biobased carbons in a volume ratio of between 40:60 and 80:20, and the polyol phase is:
   either a mixture of poly(1,3-propanediol) with a molar mass of between 200 and 300 g/mol and a poly(1,3-propanediol) with a molar mass of between 400 and 600 g/mol in a volume ratio of between 30:70 and 45:55,
   or a mixture of poly(1,3-propanediol) with a molar mass of between 200 and 300 g/mol and castor oil in a volume ratio of between 40:60 and 50:50,
the polyisocyanate phase is a mixture of pentamethylene diisocyanate isocyanurate and polyethylene glycol- and palmitic acid-terminated hexamethylene diisocyanate allophanate in a ratio of 70:30, and the polyol phase is a mixture of poly(1,3-propanediol) with a molar mass of between 200 and 300 g/mol and poly(1,3-propanediol) with a molar mass of between 400 and 600 g/mol in a volume ratio of 38:62,
the polyisocyanate phase is a mixture of pentamethylene diisocyanate isocyanurate and polyethylene glycol- and palmitic acid-terminated hexamethylene diisocyanate allophanate in a ratio of 50:50, and the polyol phase is a mixture of poly(1,3-propanediol) with a molar mass of between 200 and 300 g/mol and castor oil in a volume ratio of 45:55.

Another aspect of the invention relates to the process for manufacturing the abovementioned composition, which is essentially characterized in that it comprises at least the steps of:
providing or preparing a polyisocyanate phase of volume V1 and providing or preparing a polyol phase of volume V2, for which phases:
   either the polyisocyanate phase comprises at least two polyisocyanates each including at least 25% of biobased carbons, and the polyol phase comprises at least one polyol including at least 80% of biobased carbons,
   or the polyol phase comprises at least two polyols each including at least 80% of biobased carbons, and the polyisocyanate phase comprises at least one polyisocyanate including at least 25% of biobased carbons, and
mixing the polyisocyanate and polyol phases.

The process of the invention may also include the following optional features considered in isolation or in any possible technical combination:
the process comprises at least the steps of:
   providing or preparing a polyisocyanate phase of volume V1 comprising at least two polyisocyanates which each include at least 25% of biobased carbons,
   providing or preparing a polyol phase of volume V2 comprising at least two polyols which each include at least 80% of biobased carbons, and
   mixing the polyisocyanate and polyol phases.
the polyisocyanate phase comprises at least two polyisocyanates, one of which includes at least 50% of biobased carbons, and the polyol phase comprises at least two polyols, each of which includes at least 90% of biobased carbons.
the process also comprises the steps of:
   evaluating the isocyanate-function equivalent volume (IEVi, IEVii, . . . , IEVin) of the polyisocyanate or of each of the at least two polyisocyanates of the polyisocyanate phase,
   evaluating the alcohol-function equivalent volume (HEVh, HEVhh, . . . , HEVhn) of the polyol or of each of the at least two polyols in the polyol phase, and
   adjusting the respective volume percentage (% VIi, % VIii, . . . , % VIin) of each of the at least two polyisocyanates in the isocyanate phase and/or the respective volume percentage (% VHh, % VHhh, . . . , % VHhn) of each of the at least two polyols in the polyol phase according to the following formula:

$$V 1 * IEV = V 2 * H E V$$

where IEV is the isocyanate-function equivalent volume of the polyisocyanate phase and satisfies the following formula:

$$IEV = ( \% VIi * IEVi ) + ( \% VIii * IEVii ) + … + ( \% VIin * IEVin )$$

and where HEV is the alcohol-function equivalent volume of the polyol phase and satisfies the following formula:

$$HEV = ( \% VHh * HEVh ) + ( \% VHhh * HEVhh ) + … + ( \% VHhn * HEVhn )$$

the polyisocyanate phase is a mixture of two polyisocyanates, the polyol phase is a mixture of two polyols, and said process comprises the steps of:
   evaluating the isocyanate-function equivalent volume (IEV1, IEV2) of each of the two polyisocyanates of the polyisocyanate phase,
   evaluating the alcohol-function equivalent volume (HEV1, HEV2) of each of the two polyols in the polyol phase, and
   adjusting the respective volume percentage (% VI1, % VI2) of each of the two polyisocyanates in the polyisocyanate phase, and the respective volume percentage (% VH1, % VH2) of each of the two polyols in the polyol phase, in accordance with the following formula:

$$V 1 * IEV = V 2 * H E V$$

where IEV is the isocyanate-function equivalent volume of the polyisocyanate phase and satisfies the following formula:

$$IEV = ( \% VI 1 * IEV 1 ) + ( \% VI 2 * IEV 2 )$$

and where HEV is the alcohol-function equivalent volume of the polyol phase and satisfies the following formula:

$$HEV = ( \% VH 1 * HEV 1 ) + ( \% VH 2 * HEV 2 )$$

the volume V1 of the polyisocyanate phase is equal to the volume V2 of the polyol phase, and the adjustment of the respective volume percentages (% VI1, % VI2) of the two polyisocyanates of the isocyanate phase and of the respective volume percentages (% VH1, % VH2) of the two polyols of the polyol phase is performed according to the following formula:

$$IEV ( polyisocyanate phase ) = HEV ( polyol phase )$$

where IEV is the isocyanate-function equivalent volume of the polyisocyanate phase and satisfies the following formula:

$$IEV = ( \% VI 1 * IEV 1 ) + ( \% VI 2 * IEV 2 )$$

and where HEV is the alcohol-function equivalent volume of the polyol phase and satisfies the following formula:

$$HEV = ( \% VH 1 * HEV 1 ) + ( \% VH 2 * HEV 2 )$$

the polyisocyanate phase is a mixture of diisocyanate isocyanurate which includes at least 60% of biobased carbons and diisocyanate allophanate which includes at least 25% of biobased carbons in a volume ratio of between 40:60 and 80:20, and the polyol phase is:
   either a mixture of poly(1,3-propanediol) with a molar mass of between 200 and 300 g/mol and poly(1,3-propanediol) with a molar mass of between 400 and 600 g/mol in a volume ratio of between 30:70 and 45:55,
   or a mixture of poly(1,3-propanediol) with a molar mass of between 200 and 300 g/mol and castor oil in a volume ratio of between 40:60 and 50:50.
the polyisocyanate phase is a mixture of pentamethylene diisocyanate isocyanurate and polyethylene glycol- and palmitic acid-terminated hexamethylene diisocyanate allophanate in a ratio of 70:30, and the polyol phase is a mixture of poly(1,3-propanediol) with a molar mass of between 200 and 300 g/mol and poly(1,3-propanediol) with a molar mass of between 400 and 600 g/mol in a volume ratio of 38:62,
the polyisocyanate phase is a mixture of pentamethylene diisocyanate isocyanurate and polyethylene glycol- and palmitic acid-terminated hexamethylene diisocyanate allophanate in a ratio of 50:50, and the polyol phase is a mixture of poly(1,3-propanediol) with a molar mass of between 200 and 300 g/mol and castor oil in a volume ratio of 45:55,
the process also comprises a step of adding catalyst to the polyol phase prior to mixing the polyisocyanate and polyol phases.

Finally, the invention also relates to a printed support covered at least partly with a resin dome which is essentially characterized in that the resin dome is produced from the polyurethane resin composition as mentioned previously.

The invention and its various applications will be better understood on reading the description that follows.

### DETAILED DESCRIPTION

The biobased polyurethane resin composition of the invention comprises a mixture of a volume V1 of polyisocyanate phase, and a volume V2 of polyol phase. According to the invention, at least one of the two phases includes two compounds allowing the equivalent volume of the reactive functions of these phases to be modulated according to the intended applications and the constraints applied.

It may thus be envisaged that the polyisocyanate phase comprises at least two polyisocyanates, each of which includes at least 25% of biobased carbons, and the polyol phase comprises at least one polyol which includes at least 80% of biobased carbons.

Alternatively, it may be envisaged that the polyol phase comprises at least two polyols each including at least 80% of biobased carbons, and the polyisocyanate phase comprises at least one polyisocyanate including at least 25% of biobased carbons.

Under these assumptions, preferentially, the polyisocyanate phase comprises at least one diisocyanate isocyanurate which includes at least 60% of biobased carbons, and the polyol phase comprises at least one polyether polyol which includes 100% of biobased carbons.

In the context of the doming application, the composition comprises at least one trifunctional compound, i.e. a compound including three reactive sites, so as to be able to produce a three-dimensional resin. Diisocyanate isocyanurate fulfils this function. For other applications where it is not necessary to obtain a crosslinked material, the presence of a trifunctional compound is not necessary.

In a first embodiment of the invention, the composition comprises one polyisocyanate and two polyols. In a second embodiment of the invention, the composition comprises two polyisocyanates and one polyol.

In a preferred embodiment of the invention, the composition is a mixture of at least two polyisocyanates, for the isocyanate phase, and at least two polyols, for the polyol phase. The polyisocyanates have at least 25% of biobased carbons, preferably one of them has at least 50% of biobased carbons, more preferentially at least 60% of biobased carbons, and the polyols each have at least 90% of biobased carbons, preferably 100% of biobased carbons. The use of at least two compounds in each phase allows the reactive-function equivalent volume of each phase to be modulated more readily by using a wider spectrum of compounds in a range where the number of biobased compounds is low.

The presence of at least two polyisocyanates in the polyisocyanate phase and at least two polyols in the polyol phase thus allows the number of isocyanate and polyol reactive functions, respectively, in each phase to be modulated. Thus, depending on the intended application, it will be possible to produce a polyisocyanate phase including more or fewer reactive functions than in the polyol phase.

In certain fields, it may be desirable to have a composition in which the number of isocyanate functions is greater than the number of alcohol functions. The composition of the invention allows such a composition to be manufactured.

In the field of doming, and more particularly when no additives are added to the composition, the number of reactive functions in the two phases must be equal, notably so as to avoid the formation of air bubbles in the polyurethane resin. Specifically, an excess of isocyanate functions which do not react with alcohol functions may react with the water present in the ambient air, leading to the formation of amine and carbon dioxide, and thus bubbles in the dry composition. In this case, it is a matter of adjusting the mixture of polyisocyanates in the polyisocyanate phase and the mixture of polyols in the polyol phase so as to ensure that no excess isocyanate functions can react with water.

To this end, two polyisocyanates may be used in the polyisocyanate phase and two polyols in the polyol phase, simultaneously allowing modulation of the number of reactive functions in each, while at the same time reasonably limiting the evaluations to be performed for this purpose.

As regards doming, the phases to be mixed are in a liquid state, and it is thus a matter of mixing a volume V1 of polyisocyanate phase and a volume V2 of polyol phase. The number of reactive functions in each phase must thus be adjusted to be equal, taking into account the mixture of these phases in liquid form.

According to the invention, this is achieved by using the equivalent volume of reactive functions.

It is known practice to use the equivalent mass, expressed in grams/equivalent, to define the mass of a compound affording one equivalent of reactive site. The equivalent mass of a compound corresponds to the following formula:

$$E W = \frac{M * W}{f} \qquad Formula 1$$

where M is the molar mass in grams per mole,
W is the mass in grams, and
f is the functionality (the number of reactive functions borne by a chemical compound).

Inspired by the equivalent mass and in view of the constraints imposed in the field of doming, notably the use of phases in the liquid state, the inventors adapted the use of the equivalent mass to the equivalent volume of reactive functions.

The equivalent volume is thus the volume of a compound affording one equivalent of reactive site. The equivalent volume corresponds to the following formula:

$$E V = \frac{1}{ρ} \frac{M * W}{f} \qquad Formula 2$$

where p is the mass per unit volume in grams per cubic centimeter of the compound concerned.

The aim is thus to produce a polyisocyanate phase of volume V1 with a reactive-site equivalent volume IEV equal to the reactive-site equivalent volume HEV of the polyol phase of volume V2. The following formula must thus be satisfied:

$$IEV ( polyisocyanate phase ) = HEV ( polyol phase ) \qquad Formula 3$$

This is done by evaluating the isocyanate-function equivalent volume (IEV₁, IEV₂) of each of the two polyisocyanates in the polyisocyanate phase, and similarly evaluating the alcohol-function equivalent volume (HEV₁, HEV2) of each of the two polyols in the polyol phase. The respective volume percentages (% VI₁, % VI₂) of each of the two polyisocyanates in the polyisocyanate phase, and the respective volume percentages (% VH₁, % VH₂) of each of the two polyols in the polyol phase are then adjusted so as to satisfy the abovementioned equation, it being understood that the reactive site equivalent volume IEV of the polyisocyanate phase and the reactive site equivalent volume HEV of the polyol phase satisfy the following formulae:

$$IEV ( polyisocyanate phase ) = ( \% {VI}_{1} * {IEV}_{1} ) + ( \% {VI}_{2} * {IEV}_{2} ) \qquad Formula 4$$

where IEV₁ is the isocyanate-function equivalent volume of the first polyisocyanate
where IEV₂ is the isocyanate-function equivalent volume of the second polyisocyanate

$$HEV ( polyol phase ) = ( \% {VH}_{1} * {HEV}_{1} ) + ( \% {VH}_{2} * {HEV}_{2} ) \qquad Formula 5$$

where HEV₁ is the alcohol-function equivalent volume of the first polyol
where HEV₂ is the alcohol-function equivalent volume of the second polyol.

This method for evaluating the volume percentages of each of the compounds in the corresponding phase naturally generalizes to the use of more than two polyisocyanates in the polyisocyanate phase and more than two polyols in the polyol phase.

As regards doming, identical volumes V1 of polyisocyanate phase and V2 of polyol phase are commonly used. It is thus a matter of producing a polyisocyanate phase and a polyol phase for which, respectively, the isocyanate-function equivalent volume IEV and the alcohol-function equivalent volume HEV are equal. The respective volume percentages (% VI₁, % VI₂) of each of the two polyisocyanates in the polyisocyanate phase and the respective volume percentages (% VH₁, % VH₂) of each of the two polyols in the polyol phase are thus adjusted to satisfy the following formula:

$$( \% {VI}_{1} * {IEV}_{1} ) + ( \% {VI}_{2} * {IEV}_{2} ) = ( \% {VH}_{1} * {HEV}_{1} ) + ( \% {VH}_{2} * {HEV}_{2} ) \qquad Formula 6$$

This formula corresponds to the following more general formula:

$$IEV ( polyisocyanate phase ) = HEV ( polyol phase ) \qquad Formula 3$$

In the case of using a single compound in the polyisocyanate phase or a single compound in the polyol phase, formulae 4, 5 and 6 are adapted accordingly, in accordance with what is indicated in Examples 3 and 4.

According to the process of the invention, a catalyst is added to the polyol phase. Preferably, the catalyst is dibutyltin dilaurate. The use of a catalyst allows the gel time of the composition (setting time) to be modulated.

According to the process of the invention, each of the polyol and polyisocyanate phases is prepared in parallel. Each phase is stirred for about 30 seconds at about 2500 rpm. The two phases are then mixed for about 60 seconds at about 2500 rpm. Alternatively, stirring may be mechanical and performed in dedicated reactors. The composition is then cast onto a printed support to form a resin dome using doming techniques known to those skilled in the art.

The compounds used in each of the polyisocyanate and polyol phases are partially or totally biobased.

For the polyisocyanate phase, a mixture of diisocyanate isocyanurate including at least 60% of biobased carbons and diisocyanate allophanate including at least 25% of biobased carbons is preferably used. More preferentially, and more particularly when the volumes V1 of isocyanate phase and V2 of polyol phase are identical in the polyurethane resin composition of the invention, diisocyanate isocyanurate and diisocyanate allophanate are present in the isocyanate phase in a volume ratio of between 40:60 and 80:20. These isocyanate compounds are moreover of low toxicity.

For the polyol phase, either two polyether polyols of different molar masses or a polyether polyol and castor oil are preferably used, each polyol including 100% of biobased carbons.

In the case of using two polyether polyols, a mixture of poly(1,3-propanediol) with a molar mass between 200 and 300 g/mol and a poly(1,3-propanediol) with a molar mass between 400 and 600 g/mol is preferentially used.

More preferentially, and more particularly when the volumes V1 of polyisocyanate phase and V2 of polyol phase are identical in the polyurethane resin composition of the invention, the polyol phase is either made from a mixture of poly(1,3-propanediol) with a molar mass of between 200 and 300 g/mol and a poly(1,3-propanediol) with a molar mass of between 400 and 600 g/mol in a volume ratio of between 30:70 and 45:55, or a mixture of poly(1,3-propanediol) with a molar mass of 250 g/mol and castor oil in a volume ratio of between 40:60 and 50:50.

An important criterion for producing a polyurethane resin composition intended for doming is the viscosity. To meet this criterion, each compound in the isocyanate phase and the polyol phase has a viscosity of less than 900 mPa·s at 20° C.

If the composition and process of the invention are more particularly implemented in the context and around the constraints of the doming field, the polyurethane resin composition of the invention and its associated process can find application in many fields, notably the automotive sector, the marine sector, construction, furniture, architecture, sport or even adhesives.

In electronics, potting is the process of filling electronic components with a solid or gelatinous compound. This notably affords increased impact strength and vibration resistance, and protects the components from water, humidity and corrosive agents. The components concerned may be, but are not limited to: electronic control units, electric motors, charging connectors, door handles, capacitors, batteries, sensors, printed circuit boards or lighting.

In the electrical field, encapsulation is a process used to provide electrical insulation, flexibility and good adhesion to most substrates. Certain polyurethane resins offer exceptional resistance to saline environments and extreme temperatures. The components concerned may be, but are not limited to: igniters, submersible pumps, ignition coils, water shut-off valves, sensors, transformers, capacitors, electric motors and printed circuit boards.

Finally, the composition of the invention may also find application for the encapsulation of LED lighting fixtures exposed to the open air and requiring protection against water ingress.

### Example 1

The polyisocyanate phase is a mixture of pentamethylene diisocyanate isocyanurate sold under the name Stabio D376N by the company Mitsui Chemicals (67% of biobased carbons according to the standard ASTM D6866) and of polyethylene glycol- and palmitic acid-terminated hexamethylene diisocyanate allophanate sold under the name Tolonate X Flo 100 by the company Vencorex (between 29% and 32% of biobased carbons, according to the standard ASTM D6866).

The polyol phase is a mixture of poly(1,3-propanediol) with a molar mass of between 200 and 300 g/mol sold under the name Velvetol® H250 by the company Allessa (100% of biobased carbons according to the standard ASTM D6866) and poly(1,3-propanediol) with a molar mass of between 400 and 600 g/mol sold under the name Velvetol® H500 by the company Allessa (100% of biobased carbons according to the standard ASTM D6866).

The reactive-function equivalent volumes respectively of pentamethylene diisocyanate isocyanurate (IEV₁), polyethylene glycol- and palmitic acid-terminated hexamethylene diisocyanate allophanate (IEV₂), poly(1,3-propanediol) with a molar mass of between 200 and 300 g/mol (HEV₁) and poly(1,3-propanediol) with a molar mass of between 400 and 600 g/mol (HEV₂) are evaluated and reported in Table 1 below.

To comply with industrial doming constraints, the volume V1 of the polyisocyanate phase is equal to the volume V2 of the polyol phase.

The respective volume percentages for pentamethylene diisocyanate isocyanurate (% VI₁), polyethylene glycol- and palmitic acid-terminated hexamethylene diisocyanate allophanate (% VI₂), poly(1,3-propanediol) with a molar mass of between 200 and 300 g/mol (% VH₁) and poly(1, 3-propanediol) of molar mass between 400 and 600 g/mol (% VH₂) in each phase are adjusted so that the isocyanate-function equivalent volume of the polyisocyanate phase (IEV) is equal to the alcohol-function equivalent volume of the polyol phase (HEV).

The respective volume percentages of each compound thus correspond to the following formula:

$$( \% {VI}_{1} * {IEV}_{1} ) + ( \% {VI}_{2} * {IEV}_{2} ) = ( \% {VH}_{1} * {HEV}_{1} ) + ( \% {VH}_{2} * {HEV}_{2} ) \qquad Formula 6$$

Table 1 shows the equivalent volume of the reactive function of each compound, and also the volume percentage of each compound in the phase under consideration to satisfy the above formula. The equivalent volume of the reactive function of each phase is also indicated, along with the percentage of biobased carbons per phase.

TABLE 1
Equivalent volumes and volume percentages of each compound in the mixture

| | | | Volume | |
|---|---|---|---|---|
| | | | percentage of each | |
| | | Equivalent volume of | compound in the | Equivalent |
| Nature of the | | reactive function | phase under | volume of each |
| phase | Compound | (mL/eq) | consideration | phase (mL/eq) |
| Polyisocyanate | Stabio D-376-N | 150 (IEV1) | 70% (% VI₁) | 203 (IEV) |
| phase | Tolonate X | 328 (IEV2) | 30% (% VI₂) | |
| | Flo100 | | | |
| Polyol phase | Velvetol ® H500 | 252 (HEV1) | 62% (% VH₁) | 203 (HEV) |
| | Velvetol ® H250 | 122 (HEV1) | 38% (% VH₂) | |

Table 2 shows the respective viscosity of each compound and also that of each of the polyol and isocyanate phases.

TABLE 2
Viscosity of each compound and resulting viscosity of each phase

| | | Viscosity of each | Viscosity of each |
|---|---|---|---|
| Nature | | compound (mPa · S | phase (mPa · S |
| of the phase | Compound | at 20° C.) | at 20° C.) |
| Polyisocyanate | Stabio D-376-N | 1244 | 678 |
| phase | Tolonate X Flo | 116 | |
| | 100 | | |
| Polyol phase | Velvetol ® H500 | 150 | 256 |
| | Velvetol ® H250 | 145 | |

The polyol phase is prepared by mixing 38% by volume of Velvetol® H250 with 62% by volume of Velvetol® H500. To this polyol phase is added 0.065% by mass of dibutyltin dilaurate as catalyst. The mixture is stirred for 30 seconds at 2500 rpm.

To prepare the polyisocyanate phase, 70% by volume of Stabio D376N is mixed with 30% by volume of Tolonate X Flo 100. The mixture is stirred for 30 seconds at 2500 rpm.

50% by volume of polyol phase is then mixed with 50% by volume of polyisocyanate phase. The mixture is stirred for 60 seconds at 2500 rpm. The composition is then cast onto a printed support to form a resin dome.

Various parameters associated with the resin are evaluated and observed. The transparency is evaluated visually; ++ indicates total transparency. Table 3 below shows the results obtained, and also the percentage of biobased carbons in the composition.

TABLE 3
Physicochemical properties of the composition

| | Composition | | | | Shore A | |
|---|---|---|---|---|---|---|
| | viscosity (mPa · s) | | | Degree of | hardness | % of biobased |
| Transparency | at 20° C. | Gel time | Gel content | swelling | (ShA) | carbons |
| ++ | <900 | 3 h | 94 | 186 | 43.9 ± 0.2 | 78 |

This composition meets all the requirements imposed in the field of doming.

### Example 2

The polyisocyanate phase is a mixture of pentamethylene diisocyanate isocyanurate sold under the name Stabio D376N by the company Mitsui Chemicals (67% of biobased carbons according to the standard ASTM D6866) and of polyethylene glycol- and palmitic acid-terminated hexamethylene diisocyanate allophanate sold under the name Tolonate X Flo 100 by the company Vencorex (between 29% and 32% of biobased carbons, according to the standard ASTM D6866).

The polyol phase is a mixture of poly(1,3-propanediol) with a molar mass of between 200 and 300 g/mol, sold under the name Velvetol H250 by the company Allessa (100% of biobased carbons according to the standard ASTM D6866), and castor oil sold by the company Alberdingk Boley (100% of biobased carbons according to the standard ASTM D6866).

The reactive-function equivalent volumes respectively of pentamethylene diisocyanate isocyanurate (IEV₁), polyethylene glycol- and palmitic acid-terminated hexamethylene diisocyanate allophanate (IEV₂), poly(1,3-propanediol) with a molar mass of between 200 and 300 g/mol (HEV₁) and castor oil (HEV₂) are evaluated and reported in Table 4 below.

To comply with industrial doming constraints, the volume V1 of the polyisocyanate phase is equal to the volume V2 of the polyol phase.

The respective volume percentages for pentamethylene diisocyanate isocyanurate (% VI₁), polyethylene glycol- and palmitic acid-terminated hexamethylene diisocyanate allophanate (% VI₂), poly(1,3-propanediol) with a molar mass of between 200 and 300 g/mol (% VH₁) and castor oil (% VH₂) in each phase are adjusted so that the isocyanate-function equivalent volume of the polyisocyanate phase (IEV) is equal to the alcohol-function equivalent volume of the polyol phase (HEV).

The respective volume percentages of each compound thus correspond to the following formula:

$$( \% {VI}_{1} * {IEV}_{1} ) + ( \% {VI}_{2} * {IEV}_{2} ) = ( \% {VH}_{1} * {HEV}_{1} ) + ( \% {VH}_{2} * {HEV}_{2} ) \qquad Formula 6$$

Table 4 shows the equivalent volume of the reactive function of each compound, and also the volume percentage of each compound in the phase under consideration to satisfy the above formula. The equivalent volume of the reactive function of each phase is also indicated, along with the percentage of biobased carbons per phase.

TABLE 4
Equivalent volumes and volume percentages of each compound in the mixture

| | | | Volume | |
|---|---|---|---|---|
| | | | percentage of each | |
| | | Equivalent volume of | compound in the | Equivalent |
| Nature of the | | reactive function | phase under | volume of each |
| phase | Compound | (mL/eq) | consideration | phase (mL/eq) |
| Polyisocyanate | Stabio D-376-N | 150 (IEV1) | 50% (% VI₁) | 240 (IEV) |
| phase | Tolonate X Flo100 | 328 (IEV2) | 50% (% VI₂) | |
| Polyol phase | Castor oil | 337 (HEV1) | 55% (% VH₁) | 240 (HEV) |
| | Velvetol ® H250 | 122 (HEV1) | 45% (% VH₂) | |

Table 5 shows the respective viscosity of each compound and also that of each of the polyol and isocyanate phases.

TABLE 5
Viscosity of each compound and resulting viscosity of each phase

| | | Viscosity of each | |
|---|---|---|---|
| | | compound (mPa · S | Viscosity of each phase |
| Nature of the phase | Compound | at 20° C.) | (mPa · S at 20° C.) |
| Polyisocyanate phase | Stabio D-376-N | 1244 | 350 |
| | Tolonate X Flo 100 | 116 | |
| Polyol phase | Castor oil | 885 | 308 |
| | Velvetol ® H250 | 145 | |

The polyol phase is prepared by mixing 45% by volume of Velvetol® H250 with 55% by volume of castor oil. To this polyol phase is added 0.03% by mass of dibutyltin dilaurate as catalyst. The mixture is stirred for 30 seconds at 2500 rpm.

To prepare the isocyanate phase, 50% by volume of Stabio D376N is mixed with 50% by volume of Tolonate X Flo 100. The mixture is stirred for 30 seconds at 2500 rpm.

50% by volume of polyol phase is then mixed with 50% by volume of isocyanate phase. The mixture is stirred for 60 seconds at 2500 rpm. The composition is then cast onto a printed support to form a resin dome.

Various parameters associated with the resin are evaluated and observed. The transparency is evaluated visually; ++ indicates total transparency. Table 6 below shows the results obtained, and also the percentage of biobased carbons in the composition.

TABLE 6
Physicochemical properties of the composition

| | Composition | | | | Shore A | |
|---|---|---|---|---|---|---|
| | viscosity | | | Degree of | hardness | % of biobased |
| Transparency | (mPa · s) at 20° C. | Gel time | Gel content | swelling | (ShA) | carbons |
| ++ | <900 | 3 h 30 | 88 | 205 | 52.7 ± 0.2 | 74 |

This composition meets all the requirements imposed in the field of doming.

### Example 3

The polyisocyanate phase is a mixture of pentamethylene diisocyanate isocyanurate sold under the name Stabio D376N by the company Mitsui Chemicals (67% of biobased carbons according to the standard ASTM D6866) and of polyethylene glycol- and palmitic acid-terminated hexamethylene diisocyanate allophanate sold under the name Tolonate X Flo 100 by the company Vencorex (between 29% and 32% of biobased carbons, according to the standard ASTM D6866).

The polyol phase consists of poly(1,3-propanediol) with a molar mass of between 400 and 600 g/mol, sold under the name Velvetol H500 by the company Allessa (100% of biobased carbons according to the standard ASTM D6866). The reactive-function equivalent volumes respectively of pentamethylene

diisocyanate isocyanurate (IEV₁), polyethylene glycol- and palmitic acid-terminated hexamethylene diisocyanate allophanate (IEV₂), and poly(1,3-propanediol) with a molar mass of between 400 and 600 g/mol (HEV₁) are evaluated and reported in Table 7 below.

To comply with industrial doming constraints, the volume V1 of the isocyanate phase is equal to the volume V2 of the polyol phase.

The respective volume percentages for pentamethylene diisocyanate isocyanurate (% VI₁), polyethylene glycol- and palmitic acid-terminated hexamethylene diisocyanate allophanate (% VI₂), in the polyisocyanate phase are adjusted so that the isocyanate-function equivalent volume of the polyisocyanate phase (IEV) is equal to the alcohol-function equivalent volume of the polyol phase (HEV). The respective volume percentages of each compound thus correspond to the following formula:

$$( \% {VI}_{1} * {IEV}_{1} ) + ( \% {VI}_{2} * {IEV}_{2} ) = IEV ( polyisocyanate phase ) = HEV ( polyol phase ) \qquad Formula 7$$

Table 7 shows the equivalent volume of the reactive function of each compound, and also the volume percentage of each compound in the polyisocyanate phase to satisfy the above formula. The equivalent volume of the reactive function of each phase is also indicated, along with the percentage of biobased carbons per phase.

TABLE 7
Equivalent volumes and volume percentages of each compound in the mixture

| | | | Volume | |
|---|---|---|---|---|
| | | | percentage of each | |
| | | Equivalent volume of | compound in the | Equivalent |
| Nature of | | reactive function | phase under | volume of each |
| the phase | Compound | (mL/eq) | consideration | phase (mL/eq) |
| Polyisocyanate | Stabio D-376-N | 150 (IEV1) | 42.5% (% VI₁) | 252 (IEV) |
| phase | Tolonate X Flo100 | 328 (IEV2) | 57.5% (% VI₂) | |
| Polyol | Velvetol ® H500 | 252 (HEV1) | 100% (% VH₂) | 252 (HEV) |
| phase | | | | |

Table 8 shows the respective viscosity of each compound and also that of each of the polyol and isocyanate phases.

TABLE 8
Viscosity of each compound and resulting viscosity of each phase

| | | Viscosity of each | Viscosity of each |
|---|---|---|---|
| Nature | | compound | phase (mPa · S |
| of the phase | Compound | (mPa · S at 20° C.) | at 20° C.) |
| Polyisocyanate | Stabio D-376-N | 1244 | 339 |
| phase | Tolonate X Flo 100 | 116 | |
| Polyol phase | Velvetol ® H500 | 150 | 150 |

To prepare the polyol phase, 0.5% by mass of dibutyltin dilaurate is added to Velvetol® H500. The mixture is stirred for 30 seconds at 2500 rpm.

To prepare the isocyanate phase, 42.5% by volume of Stabio D376N is mixed with 57.5% by volume of Tolonate X Flo 100. The mixture is stirred for 30 seconds at 2500 rpm.

50% by volume of polyol phase is then mixed with 50% by volume of isocyanate phase. The mixture is stirred for 60 seconds at 2500 rpm. The composition is then cast onto a printed support to form a resin dome.

Various parameters associated with the resin are evaluated and observed. The transparency is evaluated visually; ++ indicates total transparency. Table 9 below shows the results obtained, and also the percentage of biobased carbons in the composition.

TABLE 9
Physicochemical properties of the composition

| | Composition | | | | Shore A | |
|---|---|---|---|---|---|---|
| | viscosity | | | Degree of | hardness | % of biobased |
| Transparency | (mPa · s) at 20° C. | Gel time | Gel content | swelling | (ShA) | carbons |
| ++ | <900 mPa · s | not | 199% | 96% | 49.2 ± 0.2 | 74 |
| | | determined | | | | |

This composition meets all the requirements imposed in the field of doming.

### Example 4

The isocyanate phase consists of pentamethylene diisocyanate isocyanurate sold under the name Stabio D376N by the company Mitsui Chemicals (67% of biobased carbons according to the standard ASTM D6866).

The polyol phase is a mixture of poly(1,3-propanediol) with a molar mass of between 200 and 300 g/mol sold under the name Velvetol H250 by the company Allessa (100% of biobased carbons according to the standard ASTM D6866) and poly(1,3-propanediol) with a molar mass of between 400 and 600 g/mol sold under the name Velvetol H500 by the company Allessa (100% of biobased carbons according to the standard ASTM D6866).

The reactive-function equivalent volumes respectively of pentamethylene diisocyanate isocyanurate (IEV), poly(1,3-propanediol) with a molar mass of between 400 and 600 g/mol (HEV1) and poly(1,3-propanediol) with a molar mass of between 200 and 300 g/mol (HEV2) are evaluated and reported in Table 10 below.

To comply with industrial doming constraints, the volume V1 of the isocyanate phase is equal to the volume V2 of the polyol phase.

The respective volume percentages for poly(1,3-propanediol) with a molar mass of between 400 and 600 g/mol (% HEV₁) and poly(1,3-propanediol) with a molar mass of between 200 and 300 g/mol (% HEV₂) in the polyol phase are adjusted so that the isocyanate-function equivalent volume of the polyisocyanate phase (IEV) is equal to the isocyanate-function equivalent volume of the polyol phase (HEV). The respective volume percentages of each compound thus correspond to the following formula:

$$( \% {VH}_{1} * {HEV}_{1} ) + ( \% {VH}_{2} * {HEV}_{2} ) = IEV ( polyisocyanate phase ) = HEV ( polyol phase ) \qquad Formula 8$$

Table 10 shows the equivalent volume of the reactive function of each compound, and also the volume percentage of each compound in the polyol phase to satisfy the above formula. The equivalent volume of the reactive function of each phase is also indicated, along with the percentage of biobased carbons per phase.

TABLE 10
Equivalent volumes and volume percentages of each compound in the mixture

| | | | Volume | |
|---|---|---|---|---|
| | | | percentage of each | |
| | | Equivalent volume of | compound in the | Equivalent |
| Nature of | | reactive function | phase under | volume of each |
| the phase | Compound | (mL/eq) | consideration | phase (mL/eq) |
| Alcohol | Velvetol ® H500 | 252 (IEV1) | 22% (% VI₁) | 150 (IEV) |
| phase | Velvetol ® H250 | 122 (IEV2) | 78% (% VI₂) | |
| Isocyanate | Stabio D-376-N | 150 (IEV1) | 100% (% VH₂) | 150 (HEV) |
| phase | | | | |

Table 11 shows the respective viscosity of each compound and also that of each of the polyol and isocyanate phases.

TABLE 11
Viscosity of each compound and resulting viscosity of each phase

| | | Viscosity of each | Viscosity of |
|---|---|---|---|
| Nature | | compound (mPa · | each phase |
| of the phase | Compound | S at 20° C.) | (mPa · S at 20° C.) |
| Alcohol | Velvetol ® H500 | 150 | 184 |
| phase | Velvetol ® H250 | 145 | |
| Isocyanate | Stabio D-376-N | 1244 | 1244 |
| phase | | | |

The polyol phase is prepared by mixing 78% by volume of Velvetol® H250 with 22% by volume of Velvetol® H500. To this polyol phase is added 0.5% by mass of dibutyltin dilaurate as catalyst. The mixture is stirred for 30 seconds at 2500 rpm.

The polyisocyanate phase consisting of 100% by volume of Stabio D-376-N requires no particular preparation.

50% by volume of polyol phase is then mixed with 50% by volume of polyisocyanate phase. The mixture is stirred for 60 seconds at 2500 rpm. The composition is then cast onto a printed support to form a resin dome.

Various parameters associated with the resin are evaluated and observed. The transparency is evaluated visually; ++ indicates total transparency. Table 12 below shows the results obtained, and also the percentage of biobased carbons in the composition.

TABLE 12
Physicochemical properties of the composition

| | Composition | | | | Shore A | |
|---|---|---|---|---|---|---|
| | viscosity | | | Degree of | hardness | % of biobased |
| Transparency | (mPa · s) at 20° C. | Gel time | Gel content | swelling | (ShA) | carbons |
| ++ | <900 mPa · s | not | 152% | 92% | 70.3 ± 0.2 | 82% |
| | | determined | | | | |

This composition meets all the requirements imposed in the field of doming.

1. A biobased polyurethane resin composition, obtained by mixing a first volume V1 of polyisocyanate phase, and a second volume V2 of polyol phase, wherein:
either the polyisocyanate phase comprises at least two polyisocyanates each including at least 25% of biobased carbons, and the polyol phase comprises at least one polyol including at least 80% of biobased carbons,
or the polyol phase comprises at least two polyols each including at least 80% of biobased carbons, and the polyisocyanate phase comprises at least one polyisocyanate including at least 25% of biobased carbons.

2. The composition as claimed in claim 1, wherein the number of isocyanate functions in the polyisocyanate phase is equal to the number of alcohol functions in the polyol phase.

3. The composition as claimed in claim 1, wherein
the polyisocyanate phase comprises at least one diisocyanate isocyanurate which includes at least 60% of biobased carbons, and
the polyol phase comprises at least one polyether polyol which includes 100% of biobased carbons.

4. The composition as claimed in claim 1, wherein the composition is obtained by mixing the first volume of polyisocyanate phase comprising at least two polyisocyanates which each include at least 25% of biobased carbons, and the second volume of polyol phase comprising at least two polyols which each include at least 80% of biobased carbons.

5. The composition as claimed in claim 4, wherein the composition is obtained by mixing the polyisocyanate phase comprising at least two polyisocyanates, one of which includes at least 50% of biobased carbons, and the polyol phase comprising at least two polyols, each of which includes at least 90% of biobased carbons.

6. The composition as claimed in claim 5, wherein the polyisocyante phase is made from a mixture of diisocyanate isocyanurate which includes at least 60% of biobased carbons and diisocyanate allophanate which includes at least 25% of biobased carbons.

7. The composition as claimed in claim 5, wherein the polyol phase is made from two different polyols including 100% of biobased carbons.

8. The composition as claimed in claim 7, wherein the polyol phase comprises either two polyether polyols or one polyether polyol and castor oil.

9. The composition as claimed in claim 8, wherein the polyol phase comprises a poly(1,3-propanediol) having a molar mass in a range of from 200 to 300 g/mol and a poly(1,3-propanediol) having a molar mass in a range of from 400 to 600 g/mol.

10. The composition as claimed in claim 1, wherein
the composition is obtained by mixing a same volume of polyisocyanate phase and polyol phase, and
a number of isocyanate functions in the polyisocyanate phase is equal to a number of alcohol functions in the polyol phase.

11. The composition as claimed in claim 10, wherein
the isocyanate phase is a mixture of diisocyanate isocyanurate which includes at least 60% of biobased carbons and diisocyanate allophanate which includes at least 25% of biobased carbons in a volume ratio in a range of from 40:60 to 80:20, and
the polyol phase is:
either a mixture of poly(1,3-propanediol) having a molar mass in a range of from 200 to 300 g/mol and a poly(1,3-propanediol) having a molar mass in a range of from 400 to 600 g/mol in a volume ratio in a range of from 30:70 to 45:55,
or a mixture of poly(1,3-propanediol) having a molar mass in a range of from 200 to 300 g/mol and castor oil in a volume ratio in a range of from 40:60 to 50:50.

12. The composition as claimed in claim 11, wherein
the polyisocyanate phase is a mixture of pentamethylene diisocyanate isocyanurate and polyethylene glycol- and palmitic acid-terminated hexamethylene diisocyanate allophanate in a ratio of 70:30, and
the polyol phase is a mixture of poly(1,3-propanediol) having a molar mass in a range of from 200 to 300 g/mol and poly(1,3-propanediol) having a molar mass in a range of from 400 to 600 g/mol in a volume ratio of 38:62.

13. The composition as claimed in claim 11, wherein
the polyisocyanate phase is a mixture of pentamethylene diisocyanate isocyanurate and polyethylene glycol- and palmitic acid-terminated hexamethylene diisocyanate allophanate in a ratio of 50:50, and
the polyol phase is a mixture of poly(1,3-propanediol) having a molar mass in a range of from 200 to 300 g/mol and castor oil in a volume ratio of 45:55.

14. A process for manufacturing the polyurethane resin composition as claimed in claim 1, wherein the process comprises:
providing or preparing a polyisocyanate phase having a first volume V1 and providing or preparing a polyol phase having a second volume V2, wherein:
either the polyisocyanate phase comprises at least two polyisocyanates each including at least 25% of biobased carbons, and the polyol phase comprises at least one polyol including at least 80% of biobased carbons,
or the polyol phase comprises at least two polyols each including at least 80% of biobased carbons, and the polyisocyanate phase comprises at least one polyisocyanate including at least 25% of biobased carbons, and
mixing the polyisocyanate and polyol phases.

15. The process as claimed in claim 14, wherein the process comprises:
providing or preparing the polyisocyanate phase having the first volume V1 comprising at least two polyisocyanates which each include at least 25% of biobased carbons,
providing or preparing the polyol phase having the second volume V2 comprising at least two polyols which each include at least 80% of biobased carbons, and
mixing the polyisocyanate and polyol phases.

16. The process as claimed in claim 15, wherein
the polyisocyanate phase comprises at least two polyisocyanates, one of which includes at least 50% of biobased carbons, and
the polyol phase comprises at least two polyols, each of which includes at least 90% of biobased carbons.

17. The manufacturing process as claimed in claim 14, wherein the process further comprises:
evaluating an isocyanate-function equivalent volume (IEVᵢ, IEVᵢᵢ, . . . , IEVᵢⁿ) of the polyisocyanate or of each of the at least two polyisocyanates of the polyisocyanate phase,
evaluating an alcohol-function equivalent volume (HEVₕ, HEVₕₕ, . . . , HEVₕⁿ) of the polyol or of each of the at least two polyols of the polyol phase, and
adjusting a respective volume percentage (% VIᵢ, % VIᵢᵢ, . . . , % VIᵢⁿ) of each of the at least two polyisocyanates in the isocyanate phase and/or a respective volume percentage (% VHₕ, % VHₕₕ, . . . , % VHₙⁿ) of each of the at least two polyols in the polyol phase according to the following formula:
$$V 1 * IEV = V 2 * HEV$$
where IEV is the isocyanate-function equivalent volume of the polyisocyanate phase and satisfies the following formula:
$$IEV = ( \% VIi * IEVi ) + ( \% VIii * IEVii ) + … + ( \% VIin * IEVin )$$
and where HEV is the alcohol-function equivalent volume of the polyol phase and satisfies the following formula:
$$HEV = ( \% VHh * HEVh ) + ( \% VHhh * HEVhh ) + … + ( \% VHhn * HEVhn ) .$$

18. The manufacturing process as claimed in claim 17, wherein
the polyisocyanate phase is a mixture of two polyisocyanates,
the polyol phase is a mixture of two polyols, and
the process comprises:
evaluating the isocyanate-function equivalent volume (IEV₁, IEV₂) of each of the two polyisocyanates of the polyisocyanate phase,
evaluating the alcohol-function equivalent volume (HEV₁, HEV₂) of each of the two polyols of the polyol phase, and
adjusting the respective volume percentages (% VI₁, % VI₂) of each of the two polyisocyanates in the polyisocyanate phase and the respective volume percentages (% VH₁, % VH₂) of each of the two polyols in the polyol phase according to the following formula:
$$V 1 * IEV = V 2 * HEV$$
where IEV is the isocyanate-function equivalent volume of the polyisocyanate phase and satisfies the following formula:
$$IEV = ( \% VI 1 * IEV 1 ) + ( \% VI 2 * IEV 2 )$$
and where HEV is the alcohol-function equivalent volume of the polyol phase and satisfies the following formula:
$$HEV = ( \% VH 1 * HEV 1 ) + ( \% VH 2 * HEV 2 ) .$$

19. The manufacturing process as claimed in claim 18, wherein
the first volume V1 of the polyisocyanate phase is equal to the second volume V2 of the polyol phase, and
the adjustment of the respective volume percentages (% VI₁, % VI₂) of the two polyisocyanates of the isocyanate phase and of the respective volume percentages (% VH₁, % VH₂) of the two polyols of the polyol phase is performed according to the following formula:
$$IEV ( polyisocyanate phase ) = HEV ( polyol phase )$$
where IEV is the isocyanate-function equivalent volume of the polyisocyanate phase and satisfies the following formula:
$$IEV = ( \% VI 1 * IEV 1 ) + ( \% VI 2 * IEV 2 )$$
and where HEV is the alcohol-function equivalent volume of the polyol phase and satisfies the following formula:
$$HEV = ( \% VH 1 * HEV 1 ) + ( \% VH 2 * HEV 2 ) .$$

20. The process as claimed in claim 19, wherein
the polyisocyanate phase is a mixture of diisocyanate isocyanurate which includes at least 60% of biobased carbons and diisocyanate allophanate which includes at least 25% of biobased carbons in a volume ratio in a range of from 40:60 to 80:20, and
the polyol phase is:
either a mixture of poly(1,3-propanediol) having a molar mass in a range of from 200 to 300 g/mol and poly(1,3-propanediol) having a molar mass in a range of from 400 to 600 g/mol in a volume ratio in a range of from 30:70 to 45:55,
or a mixture of poly(1,3-propanediol) having a molar mass in a range of from 200 to 300 g/mol and castor oil in a volume ratio in a range of from 40:60 to 50:50.

21. The process as claimed in claim 20, wherein
the polyisocyanate phase is a mixture of pentamethylene diisocyanate isocyanurate and polyethylene glycol- and palmitic acid-terminated hexamethylene diisocyanate allophanate in a ratio of 70:30, and
the polyol phase is a mixture of poly(1,3-propanediol) having a molar mass in a range of from 200 to 300 g/mol and poly(1,3-propanediol) having a molar mass in a range of from 400 to 600 g/mol in a volume ratio of 38:62.

22. The process as claimed in claim 20, wherein
the polyisocyanate phase is a mixture of pentamethylene diisocyanate isocyanurate and polyethylene glycol- and palmitic acid-terminated hexamethylene diisocyanate allophanate in a ratio of 50:50, and
the polyol phase is a mixture of poly(1,3-propanediol) having a molar mass in a range of from 200 to 300 g/mol and castor oil in a volume ratio of 45:55.

23. The manufacturing process as claimed in claim 14, further comprising:
adding catalyst to the polyol phase prior to mixing the polyisocyanate and polyol phases.

24. A printed support covered at least partly with a resin dome, wherein the resin dome is made from the polyurethane resin composition as claimed in claim 1.
